(19) United States
(12) Patent Application Publication
(10) Pub. No.: US 2007/0136668 A1
(43) Pub. Date: Jun. 14, 2007

(54) Multimedia short message template application system and broadcast system, multimedia short message template applying method and broadcast method

(76) Inventors: Deng-Jyi Chen, Hsinchu City (TW); Chi-Chang Hung, Pitou Township (TW); Po-Chun Yang, Yujing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/443,045

(22) Filed: May 31, 2006

(30) Foreign Application Priority Data
Dec. 14, 2005 (TW) 094144356

(51) Int. Cl. H04Q 7/20

(52) U.S. Cl. 715/716; 715/908; 455/466

(57) ABSTRACT

A multimedia short message template application system and a broadcast system, a multimedia short message template applying method and a broadcast method are disclosed. The multimedia short message template application system comprises a multimedia object, a multimedia database, a template database and an applying unit. The multimedia object includes an object content attribute and an object motion attribute. The object motion attribute includes an interaction function. The multimedia database is composed of a multimedia data. The template database is composed of short message templates. Any short message template includes a combination arrangement of a multimedia object. A corresponding short message template is found by the applying unit from the template database based on the selection chosen by a user. A corresponding multimedia data is then found from the multimedia database based on the selection chosen by the user again. Lastly, the corresponding multimedia data is loaded into the object content attribute of the short message template within the multimedia object to make a multimedia short message.

### FIELD OF THE INVENTION

The present invention relates to a multimedia short message template application system and a broadcast system, a multimedia short message template applying method and a broadcast method, and more particularly to provide a short message template in a portable communication apparatus for a user to apply and author so as to compose a multimedia short message with an interaction function.

### BACKGROUND OF THE INVENTION

An expression of a short message in a portable electronic apparatus is short message service (SMS) earlier. The SMS service is to use the portable electronic apparatus to transmit text messages. However, simple text messages are unable to satisfy people's demands since the digital age arrived. A multimedia short message then comes. If the portable electronic apparatus would like to display the multimedia short message, a multimedia messaging services (MMS) format must be utilized. The MMS doest not only transmit a various multimedia contents, but also has advantages of conventional short messages. For example, short messages could be transmitted between portable electronic apparatuses with different brand names through the MMS format. In addition, texts, pictures and music could be set for a broadcast sequence and a broadcast time. The MMS could provide various multimedia contents, but a user could only broadcast multimedia short messages, the user may not integrate multimedia source materials stored in the portable electronic apparatus to perform an interaction function.

In order to satisfy the demand for an interaction multimedia short message, the inventor of the present invention based on years of experience on related research and development invents a multimedia short message template application system and a broadcast system, a multimedia short message template applying method and a broadcast method to overcome the foregoing shortcomings.

### SUMMARY OF THE INVENTION

Accordingly, the object of the present invention is to provide a multimedia short message template application system and a broadcast system, a multimedia short message applying method and a broadcast method. Specifically, a short message template is provided in a portable communication apparatus to give a user to apply and author. A multimedia message with an interaction function is then composed.

The multimedia short message template application system includes a multimedia object, a multimedia database, a template database, an applying unit. The multimedia object includes an object content attribute and an object motion attribute. The object motion attribute includes an interaction function. The multimedia database is composed of a multimedia data. The template database is composed of a short message template. Anyone short message template includes a combination arrangement of the multimedia object. The applying unit searches the short message template corresponded from the template database based on a user selection. The applying unit then searches the multimedia data corresponded from the multimedia database based on the user selection. The multimedia data corresponded is loaded into the object content attribute of the multimedia object within the short message template to compose a multimedia short message.

The multimedia short message template application system and the broadcast system, the multimedia short message template applying method and the broadcast method have features as follows:
(1) Various interaction multimedia short message templates are provided in the portable communication apparatus to give the user to apply and author.
(2) Interaction multimedia short message which has been applied and authored is transmitted to another portable electronic apparatus so that the interaction multimedia short message could be broadcasted. The interaction multimedia short message is then triggered by the user to perform the interaction function.

Other features and advantages of the present invention and variations thereof will become apparent from the following description, drawings, and claims.

### BRIEF DESCRIPTION OF THE DRAWINGS

FIG. 1 is a block diagram illustrating a multimedia short message template application system according to an embodiment of the present invention;

FIG. 2 is a schematic diagram illustrating the multimedia short message template application system according to a preferred embodiment of the present invention;

FIG. 3 is a flowchart illustrating a multimedia short message template applying method according to an embodiment of the present invention;

FIG. 4 is a flowchart illustrating the multimedia short message template applying method according to a preferred embodiment of the present invention;

FIG. 5 is a block diagram illustrating a multimedia short message broadcast system according to an embodiment of the present invention;

FIG. 6 is a schematic diagram illustrating a multimedia short message broadcast system according to an embodiment of the present invention;

FIG. 7 is a flowchart illustrating a multimedia short message broadcast method according to an embodiment of the present invention; and

FIG. 8 is a flowchart illustrating the multimedia short message broadcast method according to a preferred embodiment of the present invention.

### DETAILED DESCRIPTION OF THE PREFERRED EMBODIMENTS

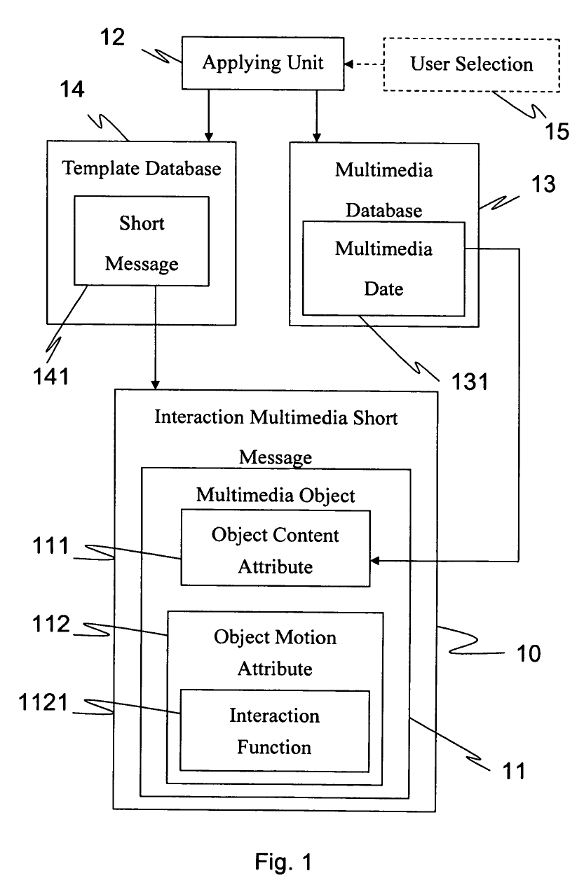

Referring to FIG. 1, a block diagram illustrates a multimedia short message template application system according to an embodiment of the present invention. The multimedia short message template application system includes a multimedia object 11, a multimedia database 13, a template database 14 and an applying unit 12. The multimedia object 11 includes an object content attribute 111 and an object motion attribute 112. The object motion attribute 112 includes an interaction function 1121. The multimedia data base 13 is composed of a multimedia data 131. The template database 14 is composed of a short message template 141. Any one short message template 141 includes a combination arrangement of the multimedia object 11. The applying unit 12 searches the short message template 141 corresponded from the template database 14 based on a user selection 15. The applying unit 12 then searches the multimedia data 131 corresponded from the multimedia database 13 based on the user selection 15. The multimedia data 131 corresponded is then loaded into the object content attribute 111 of the multimedia object 11 within the short message template 141 to compose a multimedia short message 10.

The object motion attribute 112 of the multimedia object is that the multimedia object 11 in the short message template 141 is preset to perform an action required. The interaction function 1121 of the object motion attribute 112 is that the multimedia object 11 at a short message receiving end performs a corresponding predetermined action through a user triggering. The object content attribute 111 of the multimedia object 11 is one of a picture, a text, music and a video. Any one short message template 141 in the template database 14 is different template designs.

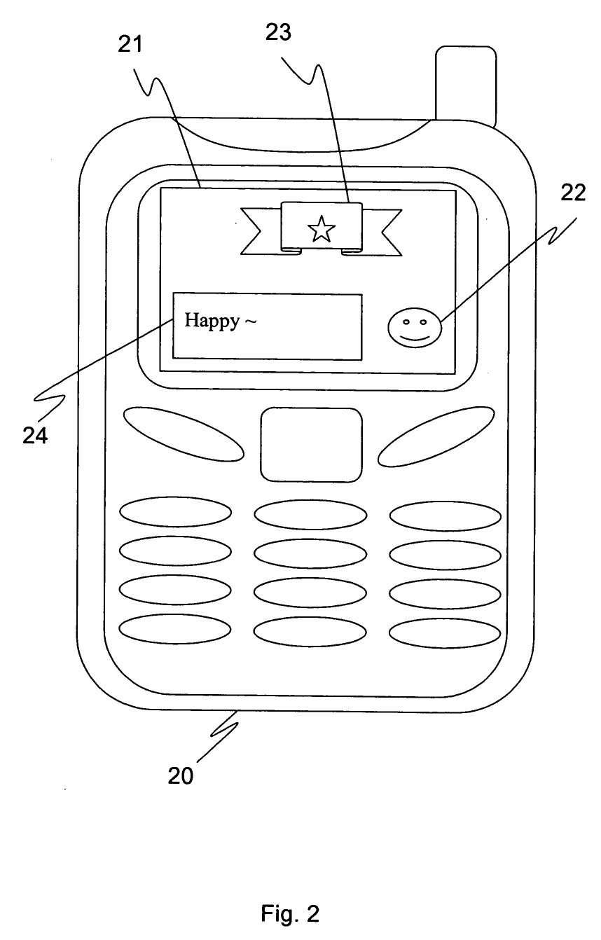

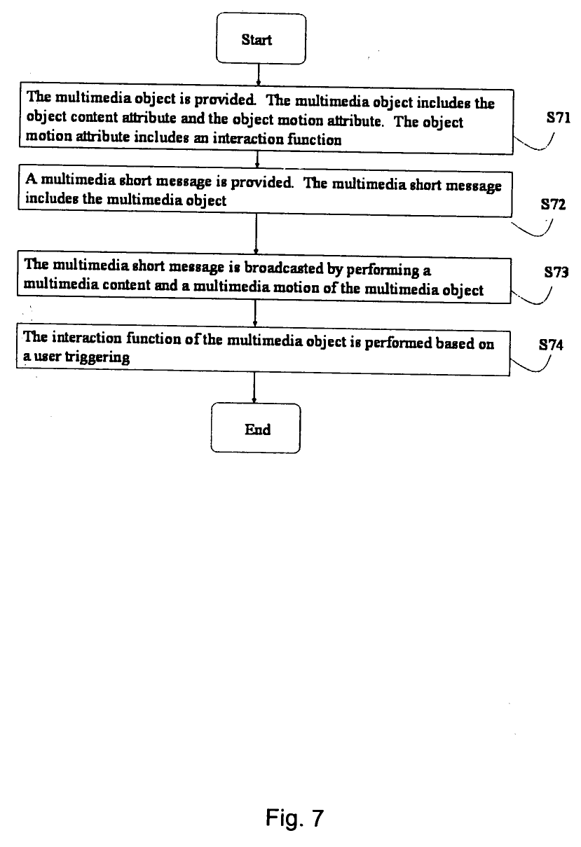

Referring to FIG. 2, a schematic diagram illustrates the multimedia short message template application system according to a preferred embodiment of the present invention. A mobile phone 20 is taken for the portable electronic apparatus for applying a short message template 21 to send a multimedia short message. The short message template includes a first multimedia object 22, a second multimedia object 23 and a third multimedia object 24. The object content attribute of the first multimedia object 22 and the object content attribute of the second multimedia object 23 are a picture. The object content attribute of the third multimedia object 24 is a text. The user could select pictures and texts from a multimedia database. Alternately the user could use the mobile phone to take pictures and input texts through keys to store in the multimedia database in order to load and apply. In addition, the object motion attribute of the second multimedia object 23 and the object motion attribute of the third multimedia object 24 does not include actions. The object motion attribute of the first multimedia object 22 includes an interaction function. The detail operation will be illustrated in FIG. 7.

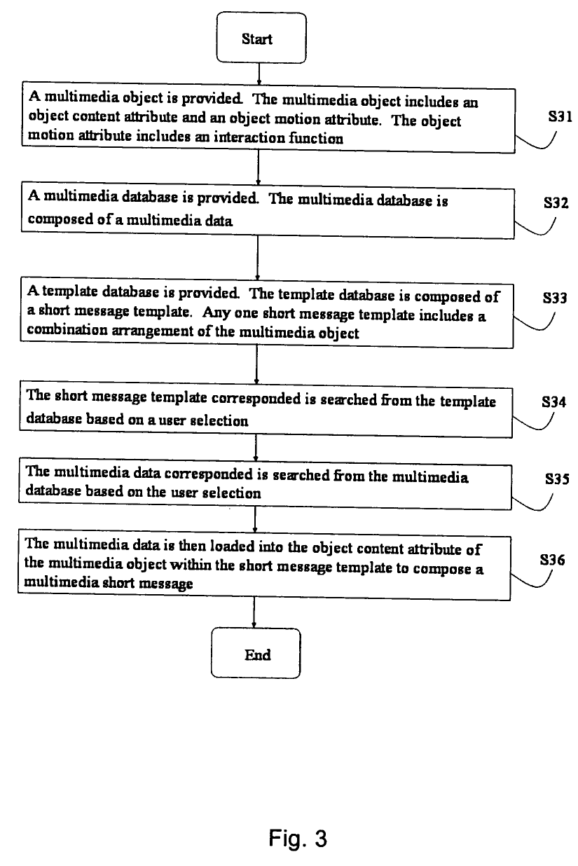

Referring to FIG. 3, a flowchart illustrates a multimedia short message template applying method according to an embodiment of the present invention. The steps are as follows:

Step S31: A multimedia object is provided. The multimedia object includes an object content attribute and an object motion attribute. The object motion attribute includes an interaction function.

Step S32: A multimedia database is provided. The multimedia database is composed of a multimedia data.

Step S33: A template database is provided. The template database is composed of a short message template. Any one short message template includes a combination arrangement of the multimedia object.

Step S34: The short message template corresponded is searched from the template database based on a user selection.

Step S35: The multimedia data corresponded is searched from the multimedia database based on the user selection.

Step S36: The multimedia data is then loaded into the object content attribute of the multimedia object within the short message template to compose a multimedia short message.

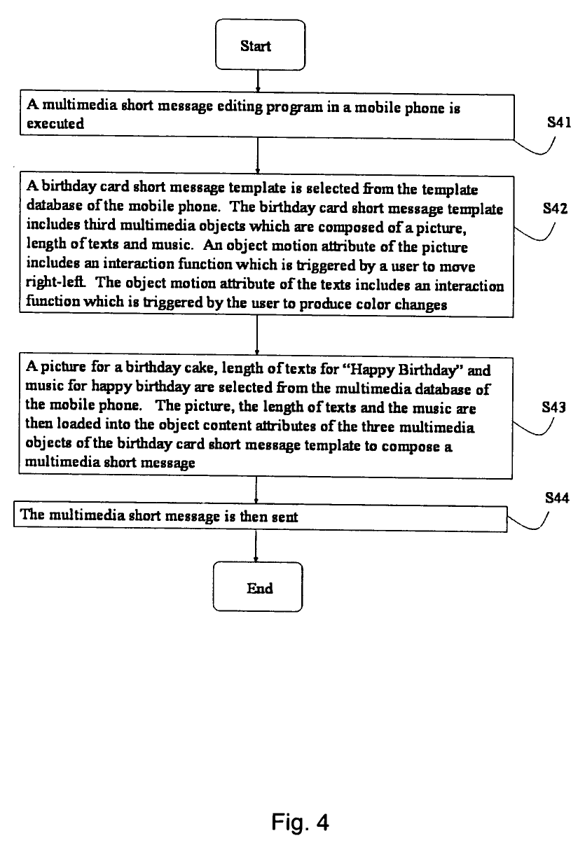

Referring to FIG. 4, a flowchart illustrates the multimedia short message template applying method according to a preferred embodiment of the present invention. The steps are as follows:

Step S41: A multimedia short message authoring program in a mobile phone is executed.

Step S42: A birthday card short message template is selected from the template database of the mobile phone. The birthday card short message template includes third multimedia objects which are composed of a picture, length of texts and music. An object motion attribute of the picture includes an interaction function which is triggered by a user to move right-left. The object motion attribute of the texts includes an interaction function which is triggered by the user to produce color changes.

Step S43: A picture for a birthday cake, length of texts for “Happy Birthday” and music for happy birthday are selected from the multimedia database of the mobile phone. The picture, the length of texts and the music are then loaded into the object content attributes of the three multimedia objects of the birthday card short message template to compose a multimedia short message.

Step S44: The multimedia short message is then sent.

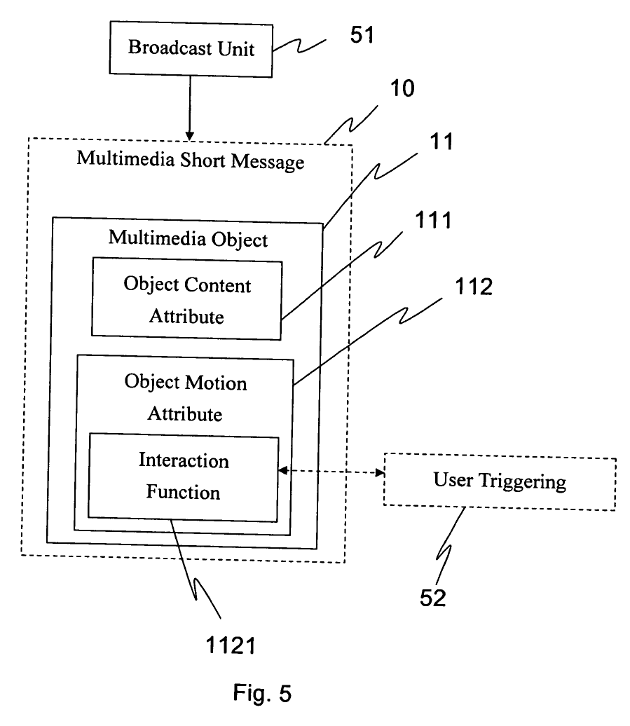

Referring to FIG. 5, a block diagram illustrates a multimedia short message broadcast system according to an embodiment of the present invention. The multimedia short message broadcast system includes the multimedia object 11, the multimedia short message 10 and a broadcast unit 51. The multimedia object 11 includes the object content attribute 111 and the object motion attribute 112. The object motion attribute 112 includes an interaction function 1121. The multimedia short message 10 includes at least one multimedia object 11. The broadcast unit 51 broadcasts the multimedia short message 10 by performing the object content attribute 111 and the object motion attribute 112 of the multimedia object 11. The broadcast unit 51 also performs the interaction function 1121 of the multimedia object 11 based on a user triggering 52.

The object motion attribute 112 of the multimedia object 11 is that the multimedia object 11 in the multimedia short message 10 is preset to perform an action required. The interaction function 1121 of the object motion attribute 112 is that the multimedia object 11 is triggered by the user triggering 52 to perform a corresponding predetermined action. The object content attribute 111 of the multimedia object 11 is one of a picture, a text, music and a video.

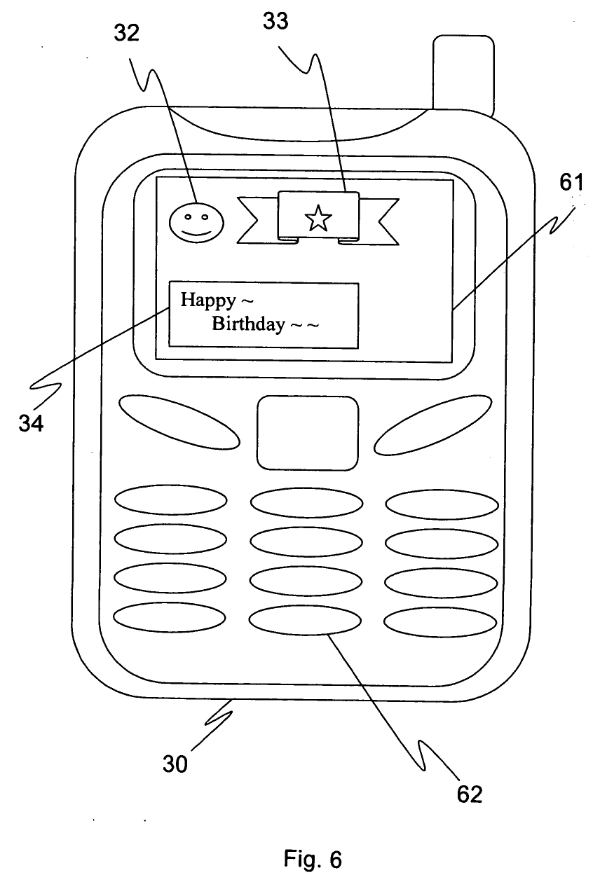

Referring to FIG. 6, a schematic diagram illustrates the multimedia short message broadcast system according to a preferred embodiment of the present invention. The mobile phone 20 is taken for the portable electronic apparatus for broadcasting a multimedia short message 61. The multimedia short message includes the first multimedia object 22, the second multimedia object 23 and the third multimedia object 24. The object content attribute of the first multimedia object 22 and the object content attribute of the second multimedia object 23 are a picture. The object content attribute of the third multimedia object 23 is a text. In addition, the object motion attribute of the third multimedia object 24 and the object motion attribute of the second multimedia object 23 do not include motions. The object motion attribute of the first multimedia object 22 includes an interaction function. When the user uses keys 62 of the mobile phone to select the first multimedia object 22, the interaction function of the object motion attribute of the first multimedia object 22 is triggered. The first multimedia object 22 then moves to an upper-left side from a lower-right side so that the user could interact with the multimedia short message.

Referring to FIG. 7, a flowchart illustrates a multimedia short message broadcast method according to an embodiment of the present invention. The steps are as follows:

Step S71: The multimedia object is provided. The multimedia object includes the object content attribute and the object motion attribute. The object motion attribute includes an interaction function.

Step S72: A multimedia short message is provided. The multimedia short message includes the multimedia object.

Step S73: The multimedia short message is broadcasted by performing a multimedia content and a multimedia motion of the multimedia object.

Step S74: The interaction function of the multimedia object is performed based on a user triggering.

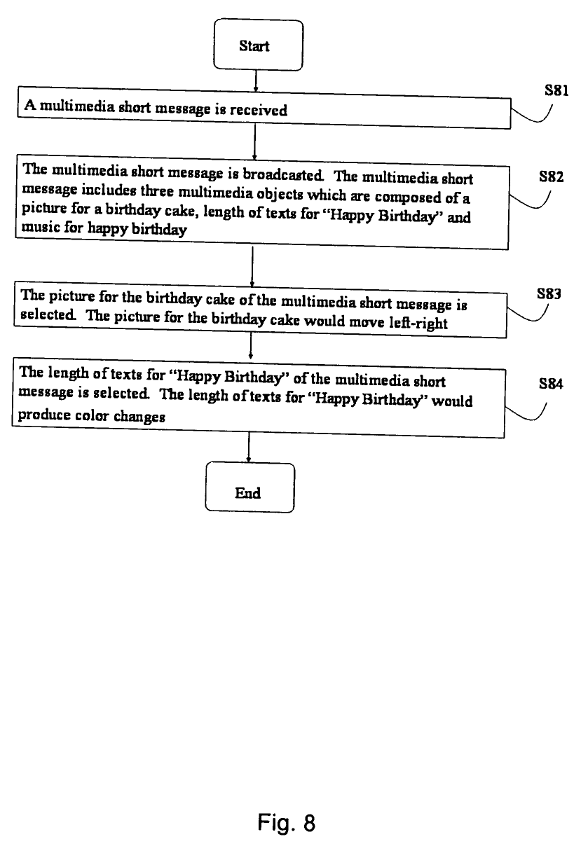

Referring to FIG. 8, a flowchart illustrates the multimedia short message broadcast method according to a preferred embodiment of the present invention. The steps are as follows:

Step S81: A multimedia short message is received.

Step S82: The multimedia short message is broadcasted. The multimedia short message includes three multimedia objects which are composed of a picture for a birthday cake, length of texts for “Happy Birthday” and music for happy birthday.

Step S83: The picture for the birthday cake of the multimedia short message is selected. The picture for the birthday cake would move left-right.

Step S84: The length of texts for “Happy Birthday” of the multimedia short message is selected. The length of texts for “Happy Birthday” would produce color changes.

Although the features and advantages of the embodiments according to the preferred invention are disclosed, it is not limited to the embodiments described above, but encompasses any and all modifications and changes within the spirit and scope of the following claims.

What is claimed is:

1. A multimedia short message template application system for use in a portable electronic apparatus, comprising:
at least one multimedia object including an object content attribute and an object motion attribute, said object motion attribute including an interaction function;
a multimedia database being composed of said multimedia data;
a template database being composed of at least one short message template, any said short message template including a combination arrangement of said multimedia object; and
an applying unit for searching said short message template from said template database based on a user selection, and said applying unit for searching said multimedia data from said multimedia database based on said user selection, said multimedia data being then loaded into said object content attribute of said multimedia object within said short message template to compose a multimedia short message.

2. The multimedia short message template application system of claim 1, wherein said object motion attribute of said multimedia object is that said multimedia object in said short message template is preset to perform an action required.

3. The multimedia short message template application system of claim 1, wherein said interaction function of said object motion attribute is that said multimedia object at a short message receiving end is triggered by a user to perform a corresponding predetermined action.

4. The multimedia short message template application system of claim 1, wherein said object content attribute of said multimedia object is one of a picture, a text, music and a video.

5. The multimedia short message template application system of claim 1, wherein said multimedia data of said multimedia database is one of a picture, a text, music and a video.

6. The multimedia short message template application system of claim 1, wherein any said short message template in said template database is different template designs.

7. A method for applying a multimedia short message template for use in a portable electronic apparatus, comprising:
providing at least one multimedia object, said multimedia object including an object content attribute and an object motion attribute, and said object motion attribute including an interaction function;
providing a multimedia database, said multimedia database being composed of at least one multimedia data;
providing a template database, said template database being composed of at least one short message template, any said short message template including a combination arrangement of said multimedia object;
searching said short message template corresponded from said template database based on a user selection;
searching said multimedia data corresponded from said multimedia data based on said user selection; and
loading said at least one multimedia data into said object content attribute of said multimedia object within said short message template to compose a multimedia short message.

8. The method for applying a multimedia short message template of claim 7, further comprising providing said multimedia object in said short message template being preset to perform an action required for said object motion attribute.

9. The method for applying a multimedia short message template of claim 7, further comprising providing said multimedia object at a short message receiving end being triggered by a user to perform a corresponding predetermined action for said interaction function of said object motion attribute.

10. The method for applying a multimedia short message template of claim 7, further comprising providing one of a picture, a text, music and a video for said object content attribute of said multimedia object.

11. The method for applying a multimedia short message template of claim 7, further comprising providing one of a picture, a text, music and a video for said multimedia data of said multimedia database.

12. The method for applying a multimedia short message template of claim 7, further comprising providing different template designs for any said short message template in said template database.

13. A multimedia short message broadcast system for use in a portable electronic apparatus, comprising:
at least one multimedia object including an object content attribute and an object motion attribute, said object motion attribute including an interaction function;
a multimedia short message including said multimedia object; and
a broadcast unit for broadcasting said multimedia short message by performing said object content attribute and said object motion attribute of said multimedia object, said broadcast unit for performing said interaction function of said multimedia object based on a user triggering.

14. The multimedia short message broadcast system of claim 13, wherein said object motion attribute of said multimedia object is that said multimedia object in said multimedia short message is preset to perform an action required.

15. The multimedia short message broadcast system of claim 13, wherein said interaction function of said object motion attribute is that said multimedia object performs a corresponding predetermined action through said user triggering.

16. The multimedia short message broadcast system of claim 13, wherein said object content attribute of said multimedia object is one of a picture, a text, music and a video.
